(19) United States
(12) Patent Application Publication
(10) Pub. No.: US 2024/0074576 A1
(43) Pub. Date: Mar. 7, 2024

(54) APPARATUS, METHODS, AND COMPUTER-READABLE MEDIUM FOR CONTROLLING POSITIONING OF A DESK

(71) Applicant: Lenovo (Singapore) Pte. Ltd., New Tech Park (SG)

(72) Inventors: John Travis Wettroth, Chapel Hil, NC (US); Samuel Patterson, Raleigh, NC (US); Kathryn Cubrilovic, Raleigh, NC (US); Brian William Wallace, Wake Forest, NC (US); Yoshihito Nakagaki, Yokohama-shi (JP)

(21) Appl. No.: 17/939,666

(22) Filed: Sep. 7, 2022

(51) Int. Cl. A47B 21/02; G06T 7/70; G06V 40/10

(52) U.S. Cl. CPC A47B 21/02; G06T 7/70; G06V 40/103; A47B 2200/0058; A47B 2200/0059; A47B 2200/006; A47B 2200/0061; A47B 2200/0062; G06T 2207/30196

(57) ABSTRACT

Apparatus, methods, and computer-readable medium are disclosed for controlling positioning of a desk. An exemplary apparatus includes a tabletop, expandable legs, motors, position sensors, a processor, and a memory configured to store instructions. The motors alter a length of one of the expandable legs. The position sensors identify current position of each of the plurality of expandable legs. The instructions cause the processor to receive a sensor signal, a communication signal, or a command signal, receive the identified current position of one or more of the expandable legs, determine a projected length value for the one or more expandable legs responsive to the received sensor signal, the communication signal, or the command signal, and command one or more of the plurality of motors based on the projected length value for the one or more expandable legs and the identified current position of the one or more expandable legs.

### FIELD

The subject matter disclosed herein relates to desks.

### BACKGROUND

Some standing desks include legs that are adjustable. A user manually adjusts each leg until desired lengths are attained.

### BRIEF SUMMARY

Table apparatuses, methods, and computer-readable medium are disclosed for adjusting the height and configuration of a table.

A table apparatus, in one embodiment, includes a tabletop, a plurality of expandable legs configured to support the tabletop, a plurality of motors, a plurality of position sensors, a processor in signal communication with the motors and the position sensors, and a memory configured to store instructions. Each of the motors is configured to alter a length of one of the plurality of expandable legs. The position sensors identify current position of each of the plurality of expandable legs. The instructions, when executed by the processor, cause the processor to receive a sensor signal, a communication signal, or a command signal, receive the identified current position of one or more of the expandable legs, determine a projected length value for the one or more expandable legs responsive to the received sensor signal, the communication signal, or the command signal, and command one or more of the plurality of motors based on the projected length value for the one or more expandable legs and the identified current position of the one or more expandable legs.

A method, in one embodiment, includes receiving a sensor signal, a communication signal, or a command signal, receiving a current position of each of a plurality of expandable legs of a table, determining a projected length value for one or more of the expandable legs responsive to the received sensor signal, the communication signal, or the command signal, and commanding one or more of a plurality of motors based on the projected length value for the one or more expandable legs and the current position of the one or more expandable legs, wherein each the plurality of motors is configured to control length of one of the expandable legs.

A computer-readable medium, in one embodiment, is configured to store instructions that, when executed by a processor, cause the processor to receive a sensor signal, a communication signal, or a command signal, receive a current position of each of a plurality of expandable legs of a table, determine a projected length value for one or more of the expandable legs responsive to the received sensor signal, the communication signal, or the command signal, and command one or more of a plurality of motors based on the projected length value for the one or more expandable legs and the current position of the one or more expandable legs, wherein each the plurality of motors is configured to control length of one of the expandable legs.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be limiting of scope, the embodiments will be described and explained with additional specificity and detail using the accompanying drawings, in which:

FIG. 1 is a schematic block diagram illustrating a table apparatus;

FIG. 2 is a cross-sectional view of a portion of the table apparatus of FIG. 1;

FIG. 3 is a perspective view of the table apparatus of FIG. 1;

FIG. 4 is a top view of the table apparatus of FIG. 1;

FIG. 5 is a side view of the table apparatus of FIG. 1;

FIG. 6 is a perspective view of the table apparatus of FIG. 1;

FIG. 7 is a schematic flow chart diagram illustrating an embodiment of a method of controlling configuration of a table apparatus.

### DETAILED DESCRIPTION

As will be appreciated by one skilled in the art, aspects of the embodiments may be embodied as a system, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, to emphasize their implementation independence more particularly. For example, a module may be implemented as a hardware circuit comprising custom very large scale integrated (VLSI) circuits or gate arrays, off-the-shelf semiconductors such as logic chips, transistors, or other discrete components. A module may also be implemented in programmable hardware devices such as a field programmable gate array (FPGA), programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (RAM), a read-only memory (ROM), an electrically erasable programmable read-only memory (EEPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be written in any combination of one or more programming languages including an object-oriented programming language such as Python, Ruby, R, Java, Java Script, Smalltalk, C++, C sharp, Lisp, Clojure, PHP, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Surface Provider).

The embodiments may transmit data between electronic devices. The embodiments may further convert the data from a first format to a second format, including converting the data from a non-standard format to a standard format and/or converting the data from the standard format to a non-standard format. The embodiments may modify, update, and/or process the data. The embodiments may store the received, converted, modified, updated, and/or processed data. The embodiments may provide remote access to the data including the updated data. The embodiments may make the data and/or updated data available in real time. The embodiments may generate and transmit a message based on the data and/or updated data in real time. The embodiments may securely communicate encrypted data. The embodiments may organize data for efficient validation. In addition, the embodiments may validate the data in response to an action and/or a lack of an action.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the figures illustrate the architecture, functionality, and operation of possible implementations of apparatuses, systems, methods, and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The apparatuses, methods, systems, program products, and their respective embodiments disclosed herein automatically adjust the length of legs of a table based predefined settings and/or sensor information. The description of elements in each figure may refer to elements of proceeding figures. Like numbers refer to like elements in all figures, including alternate embodiments of like elements.

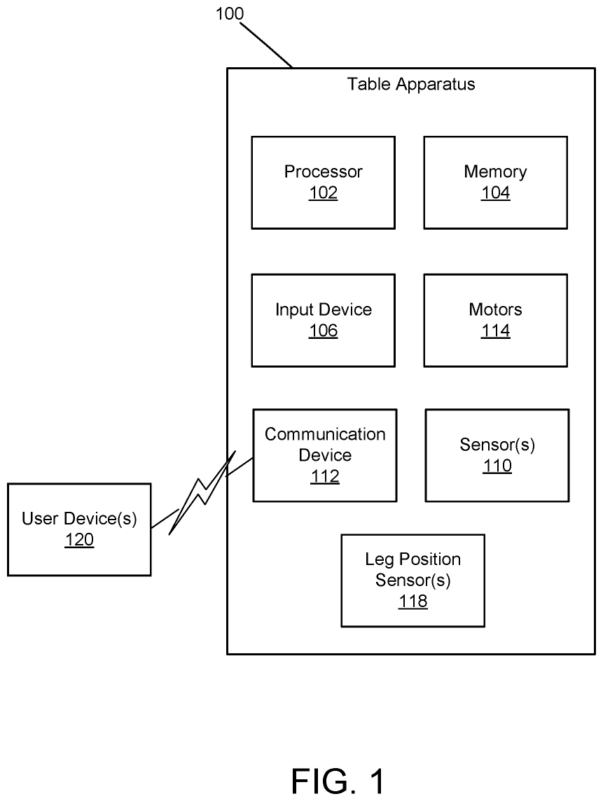

Referring to FIG. 1, in various embodiments, a table apparatus 100 includes a processor 102, a memory 104, an input device(s) 106, motors 114, sensor(s) 110, a communication device 112, and a leg position sensor(s) 118. Computer-readable instructions/code stored in the memory 104, when executed by the processor 102, cause the processor 102 to control the motors 114. The motors 114 cause extension or retraction of legs of the table apparatus 100. The processor 102 produces control signals for the motors 114 based on commands received from the input device(s) 106, information received from the communication device 112, information received from the sensor(s) 110, and/or leg position information from the leg position sensor(s) 118. Thus, the table apparatus 100 is able to automatically control height and angular position of a tabletop of the table apparatus 100 by controlling the length of the legs of the table apparatus 100. The table apparatus 100 may automatically adjust the level of the tabletop in accordance with one or more predefined configurations and/or automatically adapt in accordance with the information of an active user of the table apparatus 100.

The motors 114 may include any motor/actuator and gearing combination located between an upper leg portion and a corresponding lower leg portion of one or more the legs of the table apparatus 100.

In various embodiments, the instructions cause the processor 102 to receive identification information associated with a user device(s) 120 via the communication device 112. Information may be any information that identifies (e.g., name, height, etc.) a user. Responsive to receiving the information of the user, the instructions cause the processor 102 to generate instructions and/or commands that are sent to the motors 114.

In various embodiments, a handshake communication operation may be performed between the user device(s) 120 and the processor 102 via the communication device 112. A handshake communication operation is an automated process for information exchange between the user device(s) 120 and the processor 102. During the handshake communication operation, the processor 102 receives, via the communication device 112, various information about a user or owner of the user device(s) 120. The user device(s) 120 may be a smartphone, a laptop, a tablet computer, or the like. In certain embodiments, the handshake communication operation is triggered when the processor 102 determines that an object is placed on (or near) the table apparatus 100.

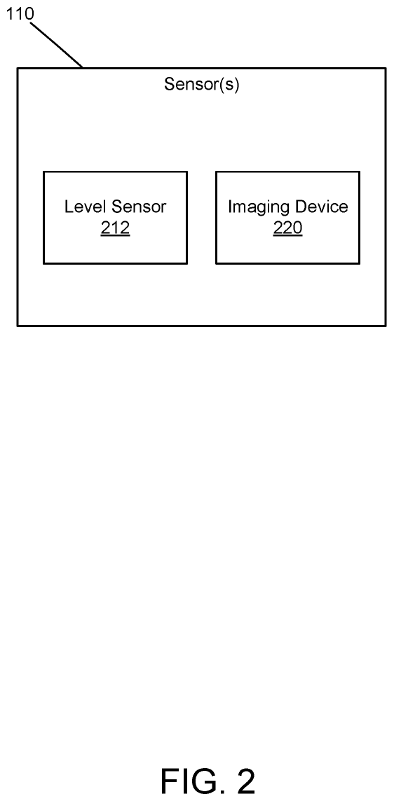

In various embodiments, referring to FIG. 2, the sensor(s) 110 identify a characteristic(s) of the table apparatus 100 and/or a characteristic(s) of a user that is in proximity to the table apparatus 100. In one embodiment, the sensor(s) 110 includes a level sensor 212 configured to provide front to back and/or side to side level information of the tabletop of the table apparatus 100. Examples of the level sensor 212 include micro-electromechanical sensors, fluid level sensors, or the like. The information produced by the level sensor 212 may be used by the processor 102 cause the motors 114 to change the leg length in order for the information produced by the level sensor 212 to match a predefined setting, such as, without limitation, a drafting table setting or other level setting.

In various embodiments, the processor 102 may also infer from the information received from the level sensor 212 that the table apparatus 100 is unstable and about to topple over. This may be caused by a child or other unstable user action applied to the table apparatus 100. The processor 102 may infer this by analyzing the change of information received from the level sensor 212 over time. A change of the information greater than a predefined threshold may cause an unstable condition. In response, the processor 102 sends commands to the motors 114 to cause the legs to extend or retract in order to mitigate the unstable condition.

In another embodiment, the sensor(s) 110 includes an imaging device 220 configured to generate information of an area or space proximate the table apparatus 100. The imaging device 220 may be a camera, motion sensor, or the like. The processor 102 may use the information produced by the imaging device 220 to identify a user presence in front of the table apparatus 100, a height value of a person detected within the image(s) produced by the imaging device 220, or the like. Based on the information from the imaging device 220 or the information produced by the processor 102 based on the information from the imaging device 220, the processor 102 will instruct the motors 114 accordingly. By way of non-limiting example, the imaging device 220 may produce an image of a person, whereby the processor 102 may determine that the image of the person in the image matches the information of a person previously stored in the memory 104, whereby the processor 102 will retrieve the associated information stored in the memory 104 in order to provide commands to the motors 114. The processor 102 determines that the user images match with information of a user named Joe that is stored in the memory 104. The stored information indicates a table height and/or tabletop level information. The previously stored information is then used by the processor 102 to cause the motors 114 to change the length of the legs if the legs are not already at a value associated with the previously stored information. The processor 102 determines leg length information based on information received form the leg position sensor(s) 118.

In various embodiments the leg position sensor(s) 118 provides height information of the tabletop and/or length information of the legs of the table apparatus 100. The leg position sensor(s) 118 may be various types of encoders, distance measuring devices, or the like. It can be appreciated to one of ordinary skill that the leg position sensor(s) 118 may be incorporated with the respective motors 114, whereby the motors 114 identify a position value which may be translated to a position and/or a height value of the respective leg.

In various embodiments, the user device(s) 120 include mobile phones, tablet computers (pad), laptop computers, palmtop computers, mobile internet devices (MID), wearable devices, virtual reality (VR) devices, augmented reality (AR) devices, personal digital assistants (PDA), handheld devices, accessory devices (including mouse, electronic stylus, and/or keyboard), computing devices or another processing devices, and/or any other suitable device configured to include user information. This is not limited in embodiments of this application.

The processor 102 may include any type of processing device, such as a microprocessor, a microcontroller, a central processing unit (CPU), a graphics processing unit (GPU), an auxiliary processing unit (APU), an FPGA, another processing device, or any component capable of executing machine-readable instructions for performing data processing according to the instructions. The memory 104 may include volatile and/or non-volatile memory, examples of which may include, but are not limited to, RAM, dynamic RAM (DRAM), synchronous DRAM (SDRAM), ROM, hard disk drive (HDD) device, and/or solid-state storage (SSD) device.

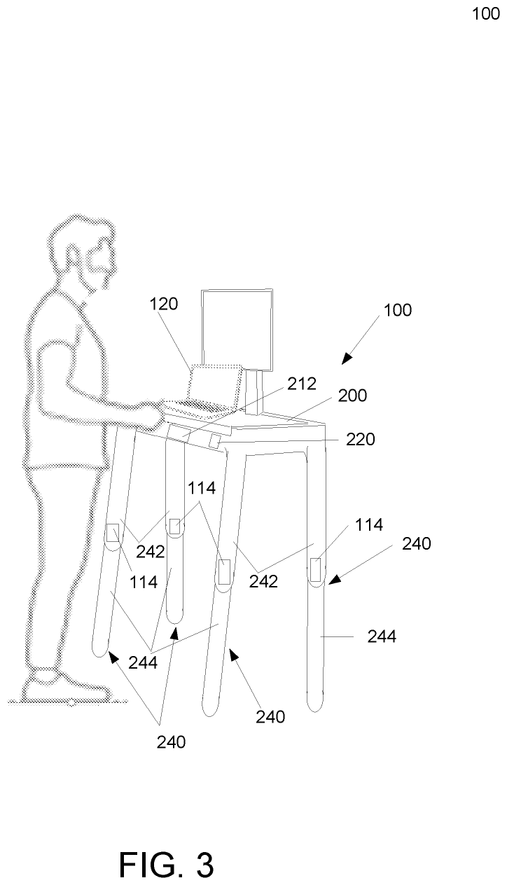

In various embodiments, as shown in FIG. 3, the table apparatus 100 includes a tabletop 200 that is supported by four legs 240. Each of the legs 240 include a top leg portion 242 and an expandable lower leg portion 244. The top leg portion 242 is attached to the tabletop 200. Included within the tabletop 200 are the level sensor 212 and the imaging device 220. Embedded within each of the legs 240 are the motors 114.

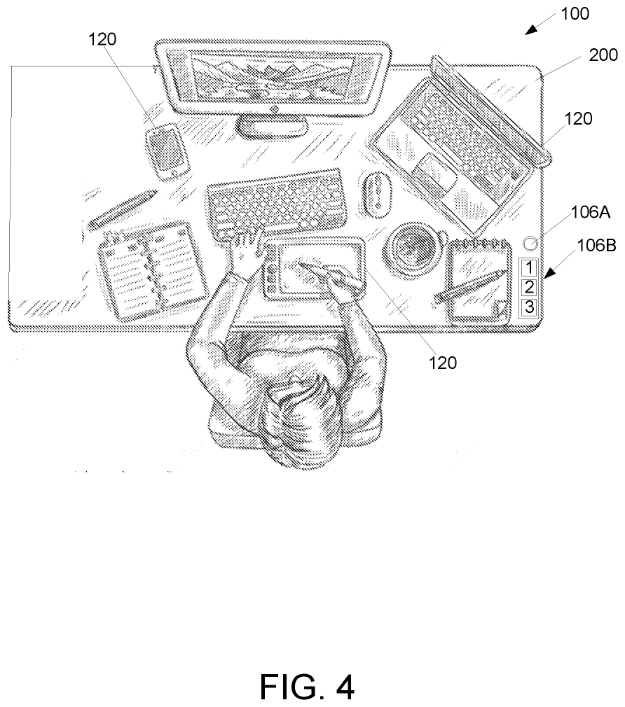

In various embodiments, as shown in FIG. 4, the tabletop 200 may include various types of input devices. The tabletop 200 may include a multidimensional input device 106A that allows a user to directly control up and down and/or pitch information for the tabletop 200 by sending control signals directly to the motors 114 in order to set the height of the tabletop 200 and/or the pitch of the tabletop 200. The multidimensional input device 106A may be joystick, a touch pad, or the like. Once a desired position and pitch of the tabletop 200 has been set by a user, the current settings may be assigned to a button included in a multi-button selector 106B. The multi-button selector 106B allows a user to select from previously stored settings for the height and/or pitch of the tabletop 200.

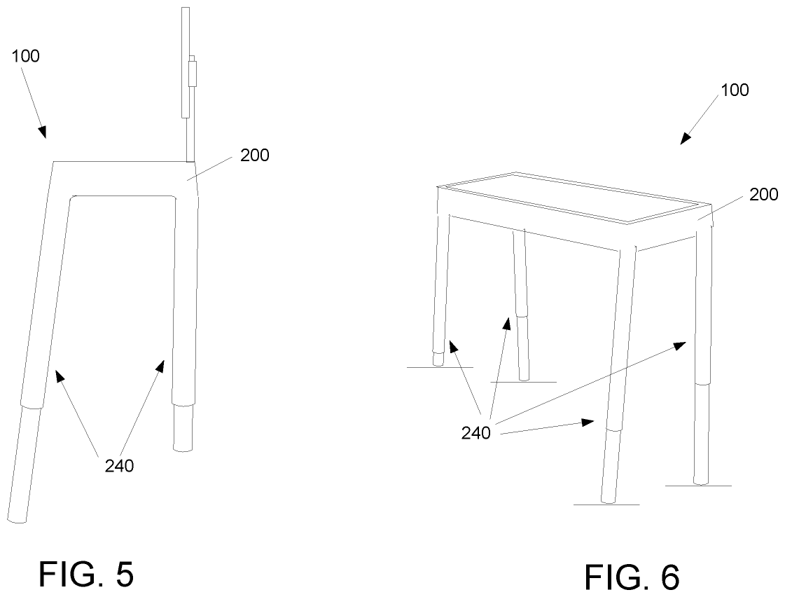

In various embodiments as shown in FIGS. 5 and 6, the memory 104 of the table apparatus 100 may include instructions that cause the processor 102 to automatically perform independent motion of the legs 240 in order to maintain a predefined configuration for the table apparatus 100 and/or the tabletop 200. By way of a non-limiting example, if the table apparatus 100 is placed on an uneven surface, the processor 102 will independently control the motors 114 for each of the legs 240 in order to allow the tabletop 200 to be at a predefined configuration, such as a level configuration, a painting easel configuration, a drafting table configuration of varying angles, or any number of different configurations.

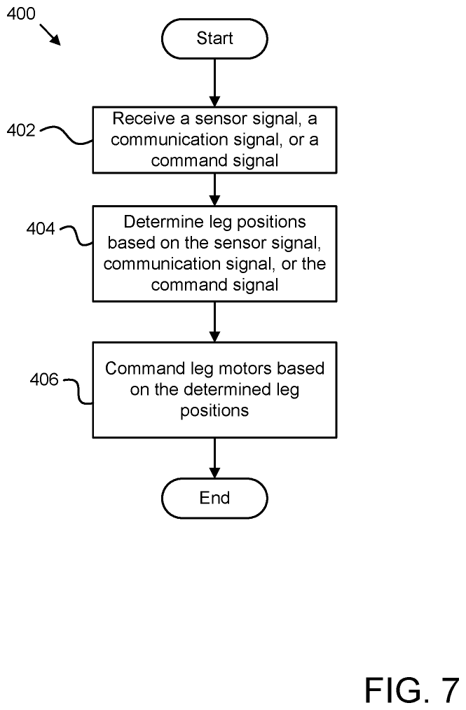

In various embodiments, referring to FIG. 7, a schematic flow chart diagram illustrates an embodiment of a method 400 for altering configuration of a table. In certain embodiments, the method 400 may be performed by a processor executing program code, for example, a microcontroller, a microprocessor, a CPU, an FPGA, or the like. At a block 402, a sensor signal, a communication signal, and or the command signal are received. At a block 404, leg positions are determined based on the sensor signal, the communication signal, or the command signal. At a block 406, the leg motors are commanded based on the determined leg positions.

### Embodiments

A. A table apparatus comprising: a tabletop; a plurality of expandable legs configured to support the tabletop; a plurality of motors, each of the motors is configured to alter a length of one of the plurality of expandable legs; a plurality of position sensors configured to identify current position of each of the plurality of expandable legs; a processor in signal communication with the motors and the position sensors; and a memory configured to store instructions. The instructions, when executed by the processor, cause the processor to: receive a sensor signal, a communication signal, or a command signal; receive the identified current position of one or more of the expandable legs; determine a projected length value for the one or more expandable legs responsive to the received sensor signal, the communication signal, or the command signal; and command one or more of the plurality of motors based on the projected length value for the one or more expandable legs and the identified current position of the one or more expandable legs.

B. The table apparatus of A, further comprising a level sensor configured to generate the sensor signal, the sensor signal comprises a level value of the tabletop, wherein the instructions further cause the processor to determine the projected length value based on the level value and a predefined level value.

C. The table apparatus of B, wherein the instructions are further configured to: sense an unstable condition based on the level value; and determine the projected length value for the one or more legs in order to counter the unstable condition.

D. The table apparatus of any of A-C, further comprising a level sensor configured to generate the sensor signal, the sensor signal, the sensor signal comprises a level value of the tabletop, wherein the instructions further cause the processor to: determine a drafting table level value based on one of the sensor signal, the communication signal, or the command signal; and determine the projected length value based on the level value and the drafting table level value.

E. The table apparatus of any of A-D, further comprising a communication device configured to receive information from a proximate user device, wherein the instructions further cause the processor to determine the projected length value is further based on the received information from the proximate user device.

F. The table apparatus of any of A-E, further comprising an image sensor configured to generate an image associated with an area proximate the table apparatus, wherein the instructions are further configured to cause the processor to: identify a user in the image; and determine the projected length value for the one or more expandable legs is further responsive to information associated with the identified user.

G. The table apparatus of any of A-F, further comprising an input device configured to allow a user to select the command signal, wherein the command signal comprises a table configuration.

H. A method comprising: receiving a sensor signal, a communication signal, or a command signal; receiving a current position of each of a plurality of expandable legs of a table; determining a projected length value for one or more of the expandable legs responsive to the received sensor signal, the communication signal, or the command signal; and commanding one or more of a plurality of motors based on the projected length value for the one or more expandable legs and the current position of the one or more expandable legs, wherein each the plurality of motors is configured to control length of one of the expandable legs.

I. The method of H, further comprising generating a level value of a tabletop of the table, wherein determining the projected length value is further based on the level value and a predefined level value.

J. The method of I, further comprising sensing an unstable condition based on the level value, wherein determining the projected length value is determined in order to counter the unstable condition.

K. The method of any of H-J, further comprising: generating a level value of a tabletop of the table; and determining a drafting table level value based on one of the sensor signal, the communication signal, or the command signal, wherein determining the projected length value is further responsive to the level value and the drafting table level value.

L. The method of any of H-K, further comprising receiving information from a proximate user device, wherein determining the projected length value is further responsive to the received information from the proximate user device.

M. The method of any of H-L, wherein the sensor signal comprises an image associated with an area proximate the table, further comprising identifying a user in the image, wherein determining the projected length value is further responsive to information associated with the identified user.

N. The method of any of H-M, further comprising receiving the command signal from an input device, wherein the command signal comprises a table configuration.

O. A non-transitory computer-readable medium configured to store instructions that, when executed by a processor, cause the processor to: receive a sensor signal, a communication signal, or a command signal; receive a current position of each of a plurality of expandable legs of a table; determine a projected length value for one or more of the expandable legs responsive to the received sensor signal, the communication signal, or the command signal; and command one or more of a plurality of motors based on the projected length value for the one or more expandable legs and the current position of the one or more expandable legs, wherein each the plurality of motors is configured to control length of one of the expandable legs.

P. The computer-readable medium of O, wherein the instructions further cause the processor to: receive a level value of a tabletop of the table; and determine the projected length value is further based on the level value and a predefined level value.

Q. The computer-readable medium of P, wherein the instructions further cause the processor to: sense an unstable condition based on the level value; and determine the projected length value is determined in order to counter the unstable condition.

R. The computer-readable medium of any of O-Q, wherein the instructions further cause the processor to: receive a level value of a tabletop of the table; determine a drafting table level value based on one of the sensor signal, the communication signal, or the command signal; and determine the projected length value is further responsive to the level value and the drafting table level value.

S. The computer-readable medium of any of O-R, wherein the instructions further cause the processor to: receive information from a proximate user device; and determine the projected length value is further responsive to the received information from the proximate user device.

T. The computer-readable medium of any of O-S, wherein the instructions further cause the processor to receive the command signal from an input device, wherein the command signal comprises a table configuration.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A table apparatus comprising:
a tabletop;
a plurality of expandable legs configured to support the tabletop;
a plurality of motors, each of the motors is configured to alter a length of one of the plurality of expandable legs;
a plurality of position sensors configured to identify current position of each of the plurality of expandable legs;
a processor in signal communication with the motors and the position sensors; and
a memory configured to store instructions that, when executed by the processor, cause the processor to:
receive a sensor signal, a communication signal, or a command signal;
receive the identified current position of one or more of the expandable legs;
determine a projected length value for the one or more expandable legs responsive to the received sensor signal, the communication signal, or the command signal; and
command one or more of the plurality of motors based on the projected length value for the one or more expandable legs and the identified current position of the one or more expandable legs.

2. The table apparatus of claim 1, further comprising a level sensor configured to generate the sensor signal, the sensor signal comprises a level value of the tabletop, wherein the instructions further cause the processor to determine the projected length value based on the level value and a predefined level value.

3. The table apparatus of claim 2, wherein the instructions are further configured to:
sense an unstable condition based on the level value; and
determine the projected length value for the one or more legs in order to counter the unstable condition.

4. The table apparatus of claim 1, further comprising a level sensor configured to generate the sensor signal, the sensor signal, the sensor signal comprises a level value of the tabletop,
wherein the instructions further cause the processor to:
determine a drafting table level value based on one of the sensor signal, the communication signal, or the command signal; and
determine the projected length value based on the level value and the drafting table level value.

5. The table apparatus of claim 1, further comprising a communication device configured to receive information from a proximate user device,
wherein the instructions further cause the processor to determine the projected length value is further based on the received information from the proximate user device.

6. The table apparatus of claim 1, further comprising an image sensor configured to generate an image associated with an area proximate the table apparatus,
wherein the instructions are further configured to cause the processor to:
identify a user in the image; and
determine the projected length value for the one or more expandable legs is further responsive to information associated with the identified user.

7. The table apparatus of claim 1, further comprising an input device configured to allow a user to select the command signal, wherein the command signal comprises a table configuration.

8. A method comprising:
receiving a sensor signal, a communication signal, or a command signal;
receiving a current position of each of a plurality of expandable legs of a table;
determining a projected length value for one or more of the expandable legs responsive to the received sensor signal, the communication signal, or the command signal; and
commanding one or more of a plurality of motors based on the projected length value for the one or more expandable legs and the current position of the one or more expandable legs, wherein each the plurality of motors is configured to control length of one of the expandable legs.

9. The method of claim 8, further comprising generating a level value of a tabletop of the table,
wherein determining the projected length value is further based on the level value and a predefined level value.

10. The method of claim 9, further comprising sensing an unstable condition based on the level value,
wherein determining the projected length value is determined in order to counter the unstable condition.

11. The method of claim 8, further comprising:
generating a level value of a tabletop of the table; and
determining a drafting table level value based on one of the sensor signal, the communication signal, or the command signal,
wherein determining the projected length value is further responsive to the level value and the drafting table level value.

12. The method of claim 8, further comprising receiving information from a proximate user device,
wherein determining the projected length value is further responsive to the received information from the proximate user device.

13. The method of claim 8, wherein the sensor signal comprises an image associated with an area proximate the table,
further comprising identifying a user in the image,
wherein determining the projected length value is further responsive to information associated with the identified user.

14. The method of claim 8, further comprising receiving the command signal from an input device,
wherein the command signal comprises a table configuration.

15. A non-transitory computer-readable medium configured to store instructions that, when executed by a processor, cause the processor to:
receive a sensor signal, a communication signal, or a command signal;
receive a current position of each of a plurality of expandable legs of a table;
determine a projected length value for one or more of the expandable legs responsive to the received sensor signal, the communication signal, or the command signal; and
command one or more of a plurality of motors based on the projected length value for the one or more expandable legs and the current position of the one or more expandable legs, wherein each the plurality of motors is configured to control length of one of the expandable legs.

16. The computer-readable medium of claim 15, wherein the instructions further cause the processor to:
receive a level value of a tabletop of the table; and
determine the projected length value is further based on the level value and a predefined level value.

17. The computer-readable medium of claim 16, wherein the instructions further cause the processor to:
sense an unstable condition based on the level value; and
determine the projected length value is determined in order to counter the unstable condition.

18. The computer-readable medium of claim 15, wherein the instructions further cause the processor to:
receive a level value of a tabletop of the table;
determine a drafting table level value based on one of the sensor signal, the communication signal, or the command signal; and
determine the projected length value is further responsive to the level value and the drafting table level value.

19. The computer-readable medium of claim 15, wherein the instructions further cause the processor to:
receive information from a proximate user device; and
determine the projected length value is further responsive to the received information from the proximate user device.

20. The computer-readable medium of claim 15, wherein the instructions further cause the processor to receive the command signal from an input device,
wherein the command signal comprises a table configuration.
